(19) United States
(12) Patent Application Publication
(10) Pub. No.: US 2026/0189950 A1
(43) Pub. Date: Jul. 2, 2026

(54) Signaling and Capability of Inter-Band SSB-Less Carrier Aggregation

(71) Applicant: Apple Inc., Cupertino, CA (US)

(72) Inventors: Peng Cheng, Beijing (CN); Haijing Hu, Los Gatos, CA (US); Dawei Zhang, Saratoga, CA (US); Yuqin Chen, Beijing (CN); Jie Cui, San Jose, CA (US); Dan Wu, Beijing (CN)

(21) Appl. No.: 18/836,318

(22) PCT Filed: Aug. 9, 2023
(86) PCT No.: PCT/CN2023/112023

§ 371 Date: Aug. 6, 2024

(51) Int. Cl. H04W 24/10; H04L 5/00

(52) U.S. Cl. CPC H04W 24/10; H04L 5/001

(57) ABSTRACT

Apparatuses, systems, and methods for inter-band carrier aggregation (CA) for co-located cells including a secondary cell (SCell) without a synchronization signal block (SSB-less). A user equipment (UE) decodes a radio resource control (RRC) information element (IE) that indicates a serving cell for timing and layer 3 (L3) measurements to enable data transmission from the UE to the SSB-less SCell. The RRC IE can be a non-zero-power channel-state-information reference signal resource set (NZP-CSI-RS-ResourceSet) IE that includes a quasi co location (QCL) information field with a serving cell index (ServCellIndex). The RRC IE can indicate a serving cell to acquire a timing and L3 measurements. If the RRC IE is absent, the UE can identify timing or L3 measurements from an intra-band serving cell that includes intra-band contiguous component carriers (CC) to the SSB-less SCell.

### FIELD

Embodiments of the invention relate to wireless communications, and more particularly to apparatuses, systems, and methods for signaling in inter-band carrier aggregation (CA) without a synchronization signal block (SSB-less) in 5G NR systems and beyond.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities.

Long Term Evolution (LTE) is currently the technology of choice for the majority of wireless network operators worldwide, providing mobile broadband data and high-speed Internet access to their subscriber base. LTE was first proposed in 2004 and was first standardized in 2008. Since then, as usage of wireless communication systems has expanded exponentially, demand has risen for wireless network operators to support a higher capacity for a higher density of mobile broadband users. Thus, in 2015 study of a new radio access technology began and, in 2017, a first release of Fifth Generation New Radio (5G NR) was standardized.

5G-NR, also simply referred to as NR, provides, as compared to LTE, a higher capacity for a higher density of mobile broadband users, while also supporting device-to-device, ultra-reliable, and massive machine type communications with lower latency and/or lower battery consumption. Further, NR may allow for more flexible UE scheduling as compared to current LTE. Consequently, efforts are being made in ongoing developments of 5G-NR to take advantage of higher throughputs possible at higher frequencies.

Network energy saving can be a consideration for environmental sustainability and for operational cost savings. As 5G becomes pervasive and handles more advanced services and applications at high data rates (e.g. XR), networks are becoming denser, using more antennas, larger bandwidths and more frequency bands. The environmental impact of 5G and improvement of network energy savings is an ongoing concern.

Much of the energy consumption can come from the radio access network and namely the Active Antenna Unit (AAU). The power consumption of a radio access can comprise two parts: a dynamic part during intermittent data transmission/reception, and a static part to constantly maintain operation of the radio access devices.

In NR, a UE receives Primary Synchronization Signal (PSS) and Secondary Synchronization Signal (SSS) to perform cell search. After cell search procedure, the UE receives Physical Broadcast Channel (PBCH) to obtain the desired system information for the subsequent reception/transmission. The Synchronization Signal (SS) and PBCH are packed as a single block called SSB. The SSB is the basis for a UE to access the network. However, continuously transmitting SSB in all serving cells in CA scenarios causes large signaling overhead and unnecessary energy consumption.

### SUMMARY

Embodiments relate to wireless communications, and more particularly to apparatuses, systems, and methods for signaling of inter-band carrier aggregation (CA) using a secondary cell (SCell) without a synchronization signal block (SSB-less), or SSB-less CA in 5G NR systems and beyond. Embodiments provide SSB-less secondary cell (SCell) operation for inter-band CA in a group of cells, where a user equipment (UE) can identify a primary cell (PCell), or another SCell, in the group of cells, with an SSB, to acquire timing and layer 3 (L3) measurements to use for the SSB-less SCell.

For example, in some embodiments, a UE can have one or more processors configured to decode, at the UE, a radio resource control (RRC) information element (IE), for a cell group configuration of a group of cells including an SCell without a synchronization signal block (SSB-less) that are used for inter-band CA. The RRC IE can indicate a serving cell in the group of cells for the UE to use to acquire a timing and L3 measurements to use for the SSB-less SCell. In addition, the one or more processors can be configured to decode, at the UE, the timing and L3 measurements from the serving cell indicated by the RRC IE to enable the one or more processors to encode data for transmission from the UE to the SSB-less SCell based on one or more of the timing or L3 measurements from the serving cell. The UE can also have a memory coupled to the one or more processors configured to store the one or more of the timing or L3 measurement from the serving cell indicated by the RRC IE.

In another example, in some embodiments, a UE can have one or more processors configured to decode, at the UE, a radio resource control (RRC) information element (IE), for a group of cells including a secondary cell (SCell) without a synchronization signal block (SSB-less) that are used for inter-band carrier aggregation (CA). The RRC IE can be a non-zero-power channel-state-information reference signal resource set (NZP-CSI-RS-ResourceSet) IE that includes a quasi co location (QCL) information field with a serving cell index (ServCellIndex) for the UE to use to acquire a timing and layer 3 (L3) measurements for the SSB-less SCell. In addition, the one or more processors can be configured to decode, at the UE, the timing and L3 measurements from the ServCellIndex indicated by the QCL information field of the NZP-CSI-RS-ResourceSet IE to enable the one or more processors to encode data for transmission from the UE to the SSB-less SCell based on one or more of the timing or L3 measurements. The UE can also have a memory coupled to the one or more processors configured to store the one or more of the timing or L3 measurements.

In another example, in some embodiments, a UE can have one or more processors configured to identify, at the UE, a radio resource control (RRC) information element (IE) when the RRC IE is present, for a cell group configuration of a group of cells including a secondary cell (SCell) without a synchronization signal block (SSB-less) that are used for inter-band carrier aggregation (CA). The RRC IE can indicate a serving cell in the group of cells for the UE to use to acquire a timing and layer 3 (L3) measurements to use for the SSB-less SCell. In addition, the one or more processors can decode, at the UE, when the RRC IE is present, the timing and L3 measurements from the serving cell indicated by the RRC IE to enable the one or more processors to encode data for transmission from the UE to the SSB-less SCell based on one or more of the timing or L3 measurements from the serving cell. Furthermore, the one or more processors can identify, at the UE, when the RRC IE is absent, timing or L3 measurements from an intra-band serving cell in the group of cells that includes intra-band contiguous component carriers (CC) to the SSB-less SCell to enable the one or more processors to encode data for transmission from the UE to the SSB-less SCell based on one or more of the timing or L3 measurements from the serving cell. The UE can also have a memory coupled to the one or more processors configured to store the one or more of the timing or L3 measurements from the serving cell indicated by the RRC IE when the RRC IE is present, or the one or more of the timing or L3 measurements from the intra-band serving cell when the RRC IE is absent.

In another example, in some embodiments, a UE operable for inter-band carrier aggregation (CA) for a group of co-located cells including a secondary cell (SCell) without a synchronization signal block (SSB-less) can comprise one or more processors configured to identify, at the UE, an active serving cell in a group of cells including a secondary cell (SCell) without a synchronization signal block (SSB-less) that are used for inter-band carrier aggregation (CA). The active serving cell is intra-band contiguous with component carriers (CC) in the SSB-less SCell. The one or more processors can decode, at the UE, timing and layer 3 (L3) measurements from the active serving cell information element (IE) to enable the one or more processors to encode data for transmission from the UE to the SSB-less SCell based on one or more of the timing or L3 measurements from the active serving cell. The UE can have a memory coupled to the one or more processors configured to store the timing from the active serving cell.

The techniques described herein may be implemented in and/or used with a number of different types of devices, including but not limited to unmanned aerial vehicles (UAVs), unmanned aerial controllers (UACs), a UTM server, base stations, access points, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1A illustrates an example wireless communication system according to some embodiments.

FIG. 1B illustrates an example of a base station and an access point in communication with a user equipment (UE) device, according to some embodiments.

FIG. 2 illustrates an example block diagram of a base station, according to some embodiments.

FIG. 3 illustrates an example block diagram of a server according to some embodiments.

FIG. 4 illustrates an example block diagram of a UE according to some embodiments.

FIG. 5 illustrates an example block diagram of cellular communication circuitry, according to some embodiments.

FIG. 6A illustrates an example of a 5G network architecture that incorporates both 3GPP (e.g., cellular) and non-3GPP (e.g., non-cellular) access to the 5G CN, according to some embodiments.

FIG. 6B illustrates an example of a 5G network architecture that incorporates both dual 3GPP (e.g., LTE and 5G NR) access and non-3GPP access to the 5G CN, according to some embodiments.

FIG. 7 illustrates an example of a baseband processor architecture for a UE, according to some embodiments.

FIG. 8 illustrates an example block diagram of a UE according to some embodiments.

FIG. 9 illustrates an example block diagram of an interface of baseband circuitry according to some embodiments.

FIG. 10 illustrates an example block diagram of a control plane protocol stack according to some embodiments.

FIG. 11 illustrates an example schematic diagram of a carrier aggregation system according to some embodiments.

FIG. 12 illustrates an example schematic diagram carrier aggregation system according to some embodiments.

FIG. 13 illustrates an example pseudo-code of the radio resource control (RRC) information (IE) signaling according to some embodiments.

FIG. 14 illustrates an example pseudo-code of the radio resource control (RRC) information (IE) signaling according to some embodiments.

FIG. 15 illustrates an example flow chart of a carrier aggregation method according to some embodiments.

FIG. 16 illustrates an example flow chart of a carrier aggregation method according to some embodiments.

FIG. 17 illustrates an example flow chart of a carrier aggregation method according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Wi-Fi—The term “Wi-Fi” (or WiFi) has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

3GPP Access—refers to accesses (e.g., radio access technologies) that are specified by 3GPP standards. These accesses include, but are not limited to, GSM/GPRS, LTE, LTE-A, and/or 5G NR. In general, 3GPP access refers to various types of cellular access technologies.

Non-3GPP Access—refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC) whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system will update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as set by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Carrier Aggregation (CA)—refers to receiving or transmitting on multiple component carriers simultaneously to create a wider channel for data transmission. Intra-band refers to using component carriers (CC) in the same operating frequency band while inter-band refers to using CC in different operating frequency bands.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

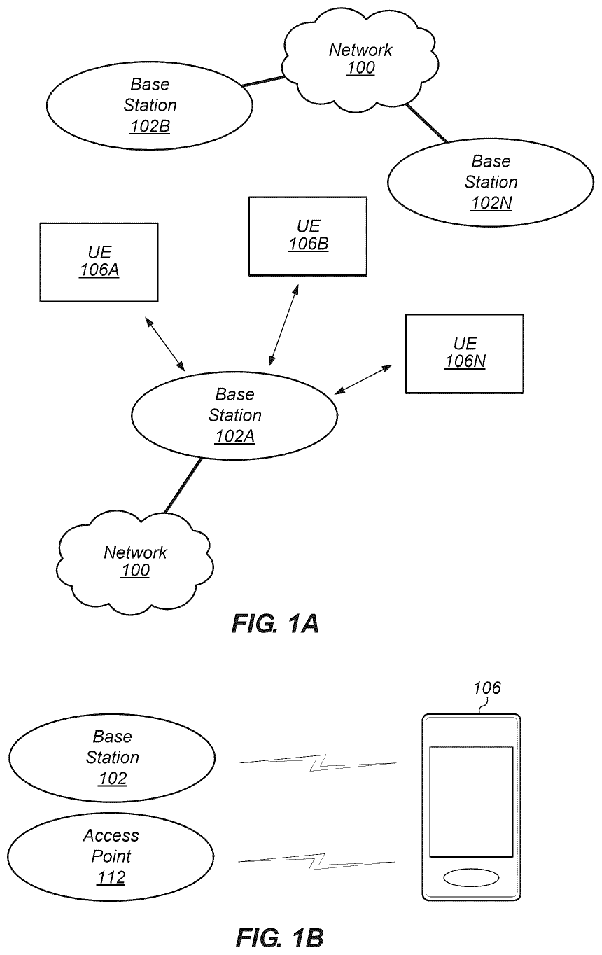

### FIGS. 1A and 1B: Communication Systems

FIG. 1A illustrates a simplified example wireless communication system, according to some embodiments. It is noted that the system of FIG. 1A is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. Note that if the base station 102A is implemented in the context of LTE, also referred to as the Evolved Universal Terrestrial Radio Access Network (E-UTRAN, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1A, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1A might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

In some embodiments, the base stations 102 can be configured for inter-band SSB-less carrier aggregation, as further described herein. One base station 102A may be a primary cell (PCell) with a radio resource control (RRC) connection, while another base station 102N may be a secondary cell (SCell) that is configured for inter-band and non-contiguous communication without a synchronization signal block (SSB-less).

FIG. 1B illustrates user equipment 106 (e.g., one of the devices 106A through 106N) in communication with a base station 102 and an access point 112, according to some embodiments. The UE 106 may be a device with both cellular communication capability and non-cellular communication capability (e.g., Bluetooth, Wi-Fi, and so forth) such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1×RTT/1×EV-DO/HRPD/eHRPD), LTE/LTE-Advanced, or 5G NR using a single shared radio and/or GSM, LTE, LTE-Advanced, or 5G NR using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1×RTTor LTE or GSM), and separate radios for communicating using each of Wi-Fi and Bluetooth. Other configurations are also possible.

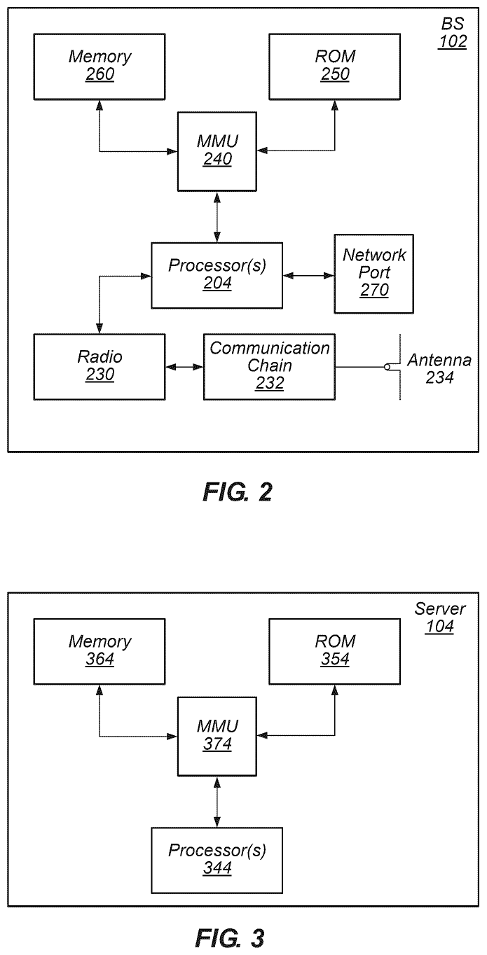

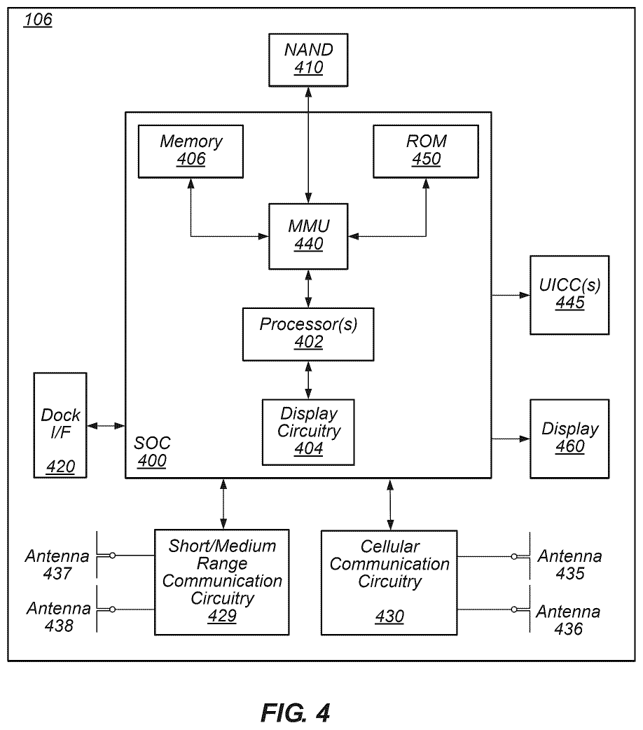

### FIG. 2: Block Diagram of a Base Station

FIG. 2 illustrates an example block diagram of a base station 102, according to some embodiments. It is noted that the base station of FIG. 2 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1 and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the BS 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (ICs) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (ICs) that are configured to perform the functions of radio 230. In addition, each integrated circuit may include circuitry (e.g., first circuitry, second circuitry, etc.) configured to perform the functions of radio 230.

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, UE devices 106, and/or UTM 108, access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network.

As described herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

### FIG. 4: Block Diagram of a UE

FIG. 4 illustrates an example simplified block diagram of a communication device 106, according to some embodiments. It is noted that the block diagram of the communication device of FIG. 4 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, an unmanned aerial vehicle (UAV), a UAV controller (UAC) and/or a combination of devices, among other devices. As shown, the communication device 106 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the communication device 106.

For example, the communication device 106 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 106, and cellular communication circuitry 430 such as for 5G NR, LTE, GSM, etc., and short to medium range wireless communication circuitry 429 (e.g., Bluetooth™ and WLAN circuitry). In some embodiments, communication device 106 may include wired communication circuitry (not shown), such as a network interface card, e.g., for Ethernet.

The cellular communication circuitry 430 may couple (e.g., communicatively; directly or indirectly) to one or more antennas, such as antennas 435 and 436 as shown. The short to medium range wireless communication circuitry 429 may also couple (e.g., communicatively; directly or indirectly) to one or more antennas, such as antennas 437 and 438 as shown. Alternatively, the short to medium range wireless communication circuitry 429 may couple (e.g., communicatively; directly or indirectly) to the antennas 435 and 436 in addition to, or instead of, coupling (e.g., communicatively; directly or indirectly) to the antennas 437 and 438. The short to medium range wireless communication circuitry 429 and/or cellular communication circuitry 430 may include multiple receive chains and/or multiple transmit chains for receiving and/or transmitting multiple spatial streams, such as in a multiple-input multiple output (MIMO) configuration.

In some embodiments, as further described below, cellular communication circuitry 430 may include dedicated receive chains (including and/or coupled to, e.g., communicatively; directly or indirectly. dedicated processors and/or radios) for multiple RATs (e.g., a first receive chain for LTE and a second receive chain for 5G NR). In addition, in some embodiments, cellular communication circuitry 430 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the UE 106 may include at least two SIMs. Each SIM may execute one or more SIM applications and/or otherwise implement SIM functionality. Thus, each SIM may be a single smart card that may be embedded, e.g., may be soldered onto a circuit board in the UE 106, or each SIM 410 may be implemented as a removable smart card. Thus, the SIM(s) may be one or more removable smart cards (such as UICC cards, which are sometimes referred to as “SIM cards”), and/or the SIMS 410 may be one or more embedded cards (such as embedded UICCs (eUICCs), which are sometimes referred to as “eSIMs” or “eSIM cards”). In some embodiments (such as when the SIM(s) include an eUICC), one or more of the SIM(s) may implement embedded SIM (eSIM) functionality; in such an embodiment, a single one of the SIM(s) may execute multiple SIM applications. Each of the SIMS may include components such as a processor and/or a memory; instructions for performing SIM/eSIM functionality may be stored in the memory and executed by the processor. In some embodiments, the UE 106 may include a combination of removable smart cards and fixed/non-removable smart cards (such as one or more eUICC cards that implement eSIM functionality), as desired. For example, the UE 106 may comprise two embedded SIMs, two removable SIMs, or a combination of one embedded SIMs and one removable SIMs. Various other SIM configurations are also contemplated.

As noted above, in some embodiments, the UE 106 may include two or more SIMs. The inclusion of two or more SIMs in the UE 106 may allow the UE 106 to support two different telephone numbers and may allow the UE 106 to communicate on corresponding two or more respective networks. For example, a first SIM may support a first RAT such as LTE, and a second SIM 410 support a second RAT such as 5G NR. Other implementations and RATs are of course possible. In some embodiments, when the UE 106 comprises two SIMs, the UE 106 may support Dual SIM Dual Active (DSDA) functionality. The DSDA functionality may allow the UE 106 to be simultaneously connected to two networks (and use two different RATs) at the same time, or to simultaneously maintain two connections supported by two different SIMs using the same or different RATs on the same or different networks. The DSDA functionality may also allow the UE 106 to simultaneously receive voice calls or data traffic on either phone number. In certain embodiments the voice call may be a packet switched communication. In other words, the voice call may be received using voice over LTE (VoLTE) technology and/or voice over NR (VoNR) technology. In some embodiments, the UE 106 may support Dual SIM Dual Standby (DSDS) functionality. The DSDS functionality may allow either of the two SIMs in the UE 106 to be on standby waiting for a voice call and/or data connection. In DSDS, when a call/data is established on one SIM, the other SIM is no longer active. In some embodiments, DSDx functionality (either DSDA or DSDS functionality) may be implemented with a single SIM (e.g., a eUICC) that executes multiple SIM applications for different carriers and/or RATs.

As shown, the SOC 400 may include processor(s) 402, which may execute program instructions for the communication device 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As described herein, the communication device 106 may include hardware and software components for implementing the above features for a communication device 106 to communicate a scheduling profile for power savings to a network. The processor 402 of the communication device 106 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (ICs) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (ICs) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more ICs that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

In some embodiments, the UE 106 can be configured for inter-band SSB-less carrier aggregation, as further described herein.

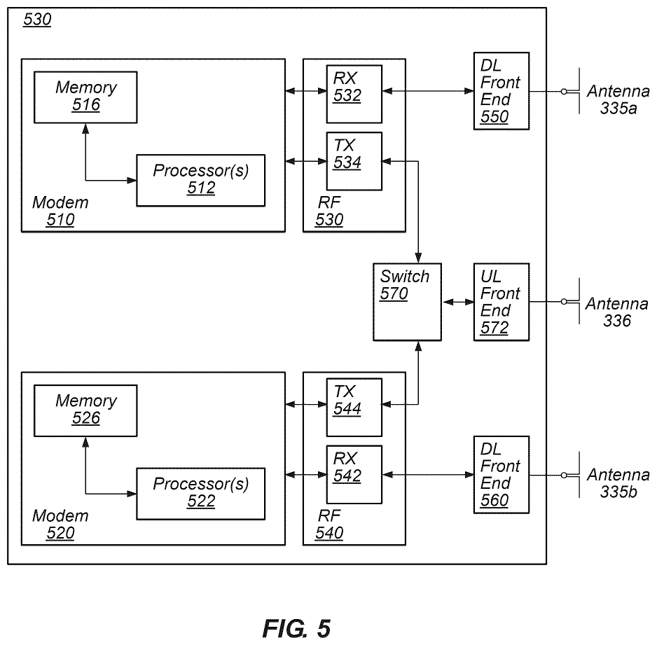

### FIG. 5: Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 530, which may be cellular communication circuitry 430, may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 530 may couple (e.g., communicatively; directly or indirectly) to one or more antennas, such as antennas 435a-b and 436 as shown (in FIG. 4). In some embodiments, cellular communication circuitry 530 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 530 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 530 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 530 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for time division multiplexing UL data for NSA NR operations, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

In some embodiments, the processors 512, 522 can be configured for inter-band SSB-less carrier aggregation, as further described herein.

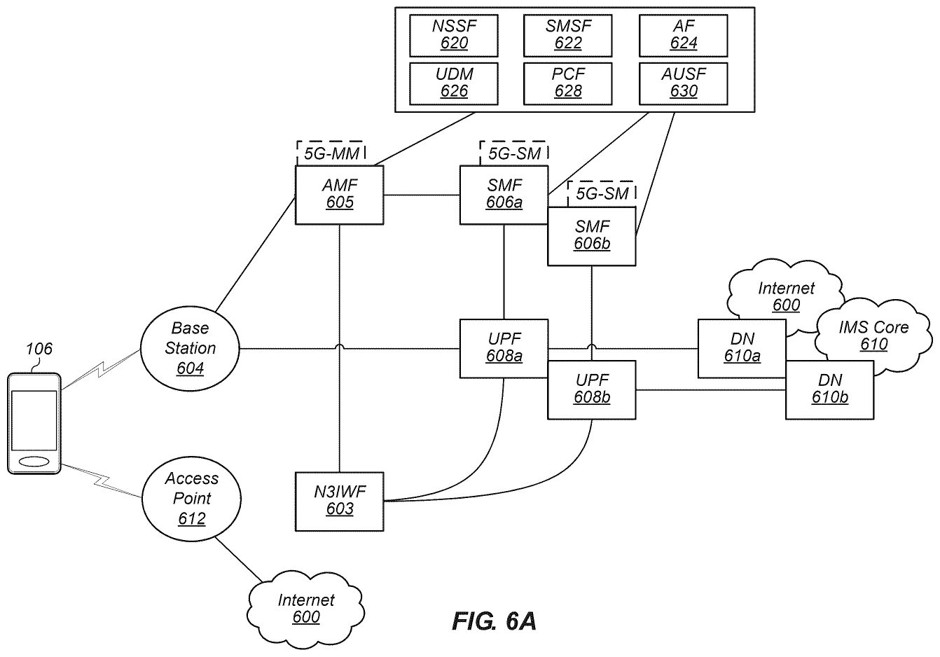

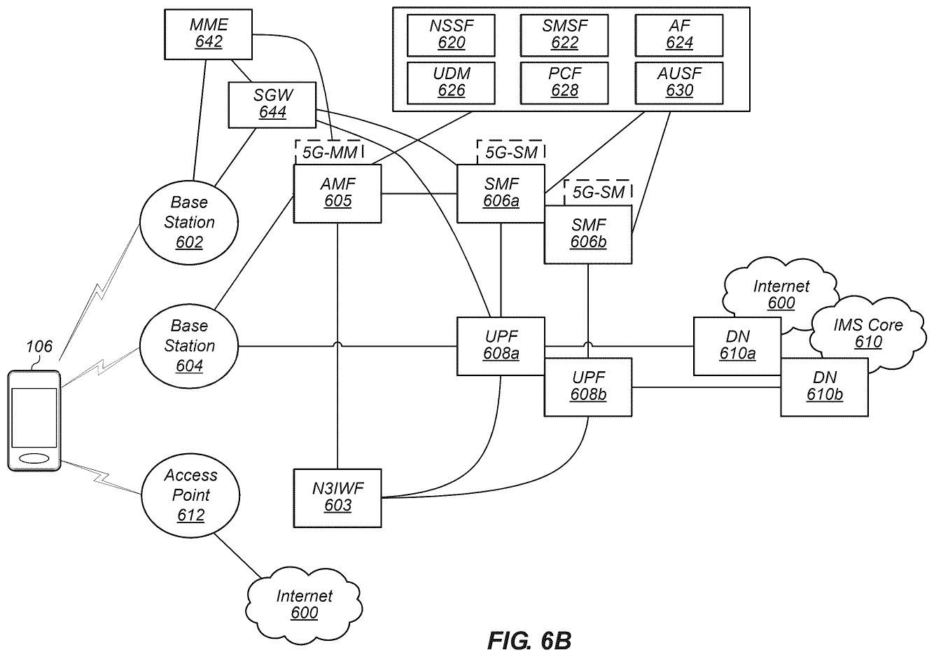

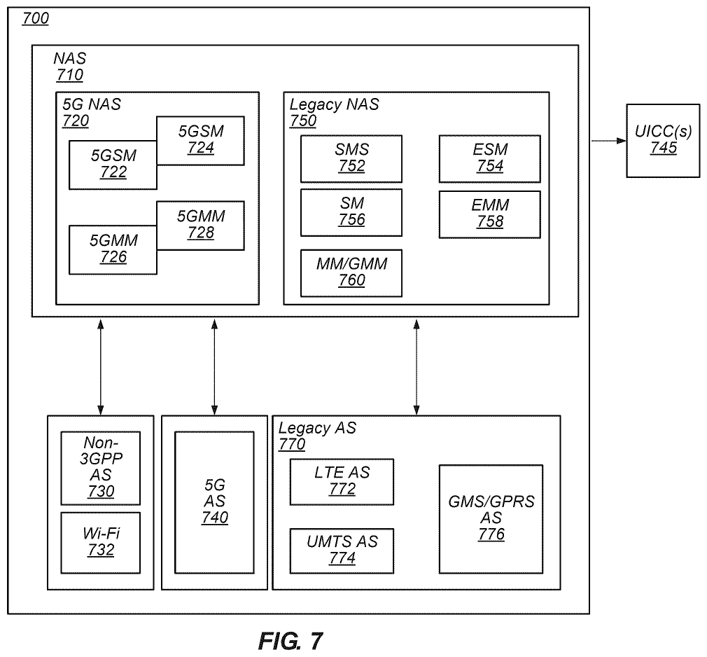

FIGS. 6A, 6B and 7: 5G Core Network Architecture—Interworking with Wi-Fi

In some embodiments, the 5G core network (CN) may be accessed via (or through) a cellular connection/interface (e.g., via a 3GPP communication architecture/protocol) and a non-cellular connection/interface (e.g., a non-3GPP access architecture/protocol such as Wi-Fi connection). FIG. 6A illustrates an example of a 5G network architecture that incorporates both 3GPP (e.g., cellular) and non-3GPP (e.g., non-cellular) access to the 5G CN, according to some embodiments. As shown, a user equipment device (e.g., such as UE 106) may access the 5G CN through both a radio access network (RAN, e.g., such as gNB 604, which may be a base station 102) and an access point, such as AP 612. The AP 612 may include a connection to the Internet 600 as well as a connection to a non-3GPP inter-working function (N3IWF) 603 network entity. The N3IWF may include a connection to a core access and mobility management function (AMF) 605 of the 5G CN. The AMF 605 may include an instance of a 5G mobility management (5G MM) function associated with the UE 106. In addition, the RAN (e.g., gNB 604) may also have a connection to the AMF 605. Thus, the 5G CN may support unified authentication over both connections as well as allow simultaneous registration for UE 106 access via both gNB 604 and AP 612. As shown, the AMF 605 may include one or more functional entities associated with the 5G CN (e.g., network slice selection function (NSSF) 620, short message service function (SMSF) 622, application function (AF) 624, unified data management (UDM) 626, policy control function (PCF) 628, and/or authentication server function (AUSF) 630). Note that these functional entities may also be supported by a session management function (SMF) 606a and an SMF 606b of the 5G CN. The AMF 605 may be connected to (or in communication with) the SMF 606a. Further, the gNB 604 may in communication with (or connected to) a user plane function (UPF) 608a that may also be communication with the SMF 606a. Similarly, the N3IWF 603 may be communicating with a UPF 608b that may also be communicating with the SMF 606b. Both UPFs may be communicating with the data network (e.g., DN 610a and 610b) and/or the Internet 600 and Internet Protocol (IP) Multimedia Subsystem/IP Multimedia Core Network Subsystem (IMS) core network 610.

FIG. 6B illustrates an example of a 5G network architecture that incorporates both dual 3GPP (e.g., LTE and 5G NR) access and non-3GPP access to the 5G CN, according to some embodiments. As shown, a user equipment device (e.g., such as UE 106) may access the 5G CN through both a radio access network (RAN, e.g., such as gNB 604 or eNB 602, which may be a base station 102) and an access point, such as AP 612. The AP 612 may include a connection to the Internet 600 as well as a connection to the N3IWF 603 network entity. The N3IWF may include a connection to the AMF 605 of the 5G CN. The AMF 605 may include an instance of the 5G MM function associated with the UE 106. In addition, the RAN (e.g., gNB 604) may also have a connection to the AMF 605. Thus, the 5G CN may support unified authentication over both connections as well as allow simultaneous registration for UE 106 access via both gNB 604 and AP 612. In addition, the 5G CN may support dual-registration of the UE on both a legacy network (e.g., LTE via eNB 602) and a 5G network (e.g., via gNB 604). As shown, the eNB 602 may have connections to a mobility management entity (MME) 642 and a serving gateway (SGW) 644. The MME 642 may have connections to both the SGW 644 and the AMF 605. In addition, the SGW 644 may have connections to both the SMF 606a and the UPF 608a. As shown, the AMF 605 may include one or more functional entities associated with the 5G CN (e.g., NSSF 620, SMSF 622, AF 624, UDM 626, PCF 628, and/or AUSF 630). Note that UDM 626 may also include a home subscriber server (HSS) function and the PCF may also include a policy and charging rules function (PCRF). Note further that these functional entities may also be supported by the SMF606a and the SMF 606b of the 5G CN. The AMF 606 may be connected to (or in communication with) the SMF 606a. Further, the gNB 604 may in communication with (or connected to) the UPF 608a that may also be communication with the SMF 606a. Similarly, the N3IWF 603 may be communicating with a UPF 608b that may also be communicating with the SMF 606b. Both UPFs may be communicating with the data network (e.g., DN 610a and 610b) and/or the Internet 600 and IMS core network 610.

FIG. 7 illustrates an example of a baseband processor architecture for a UE (e.g., such as UE 106), according to some embodiments. The baseband processor architecture 700 described in FIG. 7 may be implemented on one or more radios (e.g., radios 429 and/or 430 described above) or modems (e.g., modems 510 and/or 520) as described above. As shown, the non-access stratum (NAS) 710 may include a 5G NAS 720 and a legacy NAS 750. The legacy NAS 750 may include a communication connection with a legacy access stratum (AS) 770. The 5G NAS 720 may include communication connections with both a 5G AS 740 and a non-3GPP AS 730 and Wi-Fi AS 732. The 5G NAS 720 may include functional entities associated with both access stratums. Thus, the 5G NAS 720 may include multiple 5G MM entities 726 and 728 and 5G session management (SM) entities 722 and 724. The legacy NAS 750 may include functional entities such as short message service (SMS) entity 752, evolved packet system (EPS) session management (ESM) entity 754, session management (SM) entity 756, EPS mobility management (EMM) entity 758, and mobility management (MM)/GPRS mobility management (GMM) entity 760. In addition, the legacy AS 770 may include functional entities such as LTE AS 772, UMTS AS 774, and/or GSM/GPRS AS 776.

Thus, the baseband processor architecture 700 allows for a common 5G-NAS for both 5G cellular and non-cellular (e.g., non-3GPP access). Note that as shown, the 5G MM may maintain individual connection management and registration management state machines for each connection. Additionally, a device (e.g., UE 106) may register to a single PLMN (e.g., 5G CN) using 5G cellular access as well as non-cellular access. Further, it may be possible for the device to be in a connected state in one access and an idle state in another access and vice versa. Finally, there may be common 5G-MM procedures (e.g., registration, de-registration, identification, authentication, as so forth) for both accesses.

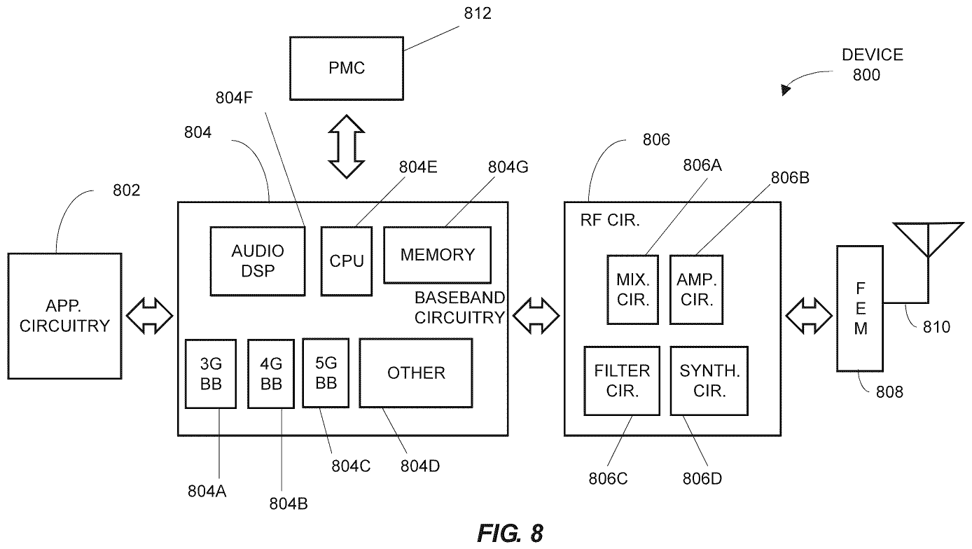

### FIG. 8: Block Diagram of a UE

FIG. 8 illustrates example components of a device 800 in accordance with some embodiments. It is noted that the device of FIG. 8 is merely one example of a possible system, and that features of this disclosure may be implemented in any of various UEs, as desired.

In some embodiments, the device 800 may include application circuitry 802, baseband circuitry 804, Radio Frequency (RF) circuitry 806, front-end module (FEM) circuitry 808, one or more antennas 810, and power management circuitry (PMC) 812 coupled together at least as shown. The components of the illustrated device 800 may be included in a UE 106 or a RAN node. In some embodiments, the device 800 may include less elements (e.g., a RAN node may not utilize application circuitry 802, and instead include a processor/controller to process IP data received from an EPC). In some embodiments, the device 800 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 802 may include one or more application processors. For example, the application circuitry 802 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 800. In some embodiments, processors of application circuitry 802 may process IP data packets received from an EPC.

The baseband circuitry 804 may include circuitry such as, but not limited to, one or more single-core or multi-core processors. The baseband circuitry 804 may include one or more baseband processors or control logic to process baseband signals received from a receive signal path of the RF circuitry 806 and to generate baseband signals for a transmit signal path of the RF circuitry 806. Baseband processing circuitry 804 may interface with the application circuitry 802 for generation and processing of the baseband signals and for controlling operations of the RF circuitry 806. For example, in some embodiments, the baseband circuitry 804 may include a third generation (3G) baseband processor 804A, a fourth generation (4G) baseband processor 804B, a fifth generation (5G) baseband processor 804C, or other baseband processor(s) 804D for other existing generations, generations in development or to be developed in the future (e.g., second generation (2G), sixth generation (6G), etc.). The baseband circuitry 804 (e.g., one or more of baseband processors 804A-D) may handle various radio control functions that enable communication with one or more radio networks via the RF circuitry 806. In other embodiments, some or all of the functionality of baseband processors 804A-D may be included in modules stored in the memory 804G and executed via a Central Processing Unit (CPU) 804E. The radio control functions may include, but are not limited to, signal modulation/demodulation, encoding/decoding, radio frequency shifting, etc. In some embodiments, modulation/demodulation circuitry of the baseband circuitry 804 may include Fast-Fourier Transform (FFT), precoding, or constellation mapping/demapping functionality. In some embodiments, encoding/decoding circuitry of the baseband circuitry 804 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 804 may include one or more audio digital signal processor(s) (DSP) 804F. The audio DSP(s) 804F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 804 and the application circuitry 802 may be implemented together such as, for example, on a system on a chip (SOC).

In some embodiments, the baseband circuitry 804 may provide for communication compatible with one or more radio technologies. For example, in some embodiments, the baseband circuitry 804 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 804 is configured to support radio communications of more than one wireless protocol may be referred to as multi-mode baseband circuitry.

RF circuitry 806 may enable communication with wireless networks using modulated electromagnetic radiation through a non-solid medium. In various embodiments, the RF circuitry 806 may include switches, filters, amplifiers, etc. to facilitate the communication with the wireless network. RF circuitry 806 may include a receive signal path which may include circuitry to down-convert RF signals received from the FEM circuitry 808 and provide baseband signals to the baseband circuitry 804. RF circuitry 806 may also include a transmit signal path which may include circuitry to up-convert baseband signals provided by the baseband circuitry 804 and provide RF output signals to the FEM circuitry 808 for transmission.

In some embodiments, the receive signal path of the RF circuitry 806 may include mixer circuitry 806a, amplifier circuitry 806b and filter circuitry 806c. In some embodiments, the transmit signal path of the RF circuitry 806 may include filter circuitry 806c and mixer circuitry 806a. RF circuitry 806 may also include synthesizer circuitry 806d for synthesizing a frequency for use by the mixer circuitry 806a of the receive signal path and the transmit signal path. In some embodiments, the mixer circuitry 806a of the receive signal path may be configured to down-convert RF signals received from the FEM circuitry 808 based on the synthesized frequency provided by synthesizer circuitry 806d. The amplifier circuitry 806b may be configured to amplify the down-converted signals and the filter circuitry 806c may be a low-pass filter (LPF) or band-pass filter (BPF) configured to remove unwanted signals from the down-converted signals to generate output baseband signals. Output baseband signals may be provided to the baseband circuitry 804 for further processing. In some embodiments, the output baseband signals may be zero-frequency baseband signals, although this is not a necessity. In some embodiments, mixer circuitry 806a of the receive signal path may comprise passive mixers, although the scope of the embodiments is not limited in this respect.

In some embodiments, the mixer circuitry 806a of the transmit signal path may be configured to up-convert input baseband signals based on the synthesized frequency provided by the synthesizer circuitry 806d to generate RF output signals for the FEM circuitry 808. The baseband signals may be provided by the baseband circuitry 804 and may be filtered by filter circuitry 806c.

In some embodiments, the mixer circuitry 806a of the receive signal path and the mixer circuitry 806a of the transmit signal path may include two or more mixers and may be arranged for quadrature downconversion and upconversion, respectively. In some embodiments, the mixer circuitry 806a of the receive signal path and the mixer circuitry 806a of the transmit signal path may include two or more mixers and may be arranged for image rejection (e.g., Hartley image rejection). In some embodiments, the mixer circuitry 806a of the receive signal path and the mixer circuitry 806a may be arranged for direct downconversion and direct upconversion, respectively. In some embodiments, the mixer circuitry 806a of the receive signal path and the mixer circuitry 806a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 806 may include analog-to-digital converter (ADC) and digital-to-analog converter (DAC) circuitry and the baseband circuitry 804 may include a digital baseband interface to communicate with the RF circuitry 806.

In some dual-mode embodiments, a separate radio IC circuitry may be provided for processing signals for each spectrum, although the scope of the embodiments is not limited in this respect.

In some embodiments, the synthesizer circuitry 806d may be a fractional-N synthesizer or a fractional N/N+1 synthesizer, although the scope of the embodiments is not limited in this respect as other types of frequency synthesizers may be suitable. For example, synthesizer circuitry 806d may be a delta-sigma synthesizer, a frequency multiplier, or a synthesizer comprising a phase-locked loop with a frequency divider.

The synthesizer circuitry 806d may be configured to synthesize an output frequency for use by the mixer circuitry 806a of the RF circuitry 806 based on a frequency input and a divider control input. In some embodiments, the synthesizer circuitry 806d may be a fractional N/N+1 synthesizer.

In some embodiments, frequency input may be provided by a voltage controlled oscillator (VCO), although that is not a necessity. Divider control input may be provided by either the baseband circuitry 804 or the applications processor 802 depending on the desired output frequency. In some embodiments, a divider control input (e.g., N) may be determined from a look-up table based on a channel indicated by the applications processor 802.

Synthesizer circuitry 806d of the RF circuitry 806 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 806d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 806 may include an IQ/polar converter.

FEM circuitry 808 may include a receive signal path which may include circuitry configured to operate on RF signals received from one or more antennas 810, amplify the received signals and provide the amplified versions of the received signals to the RF circuitry 806 for further processing. FEM circuitry 808 may also include a transmit signal path which may include circuitry configured to amplify signals for transmission provided by the RF circuitry 806 for transmission by one or more of the one or more antennas 810. In various embodiments, the amplification through the transmit or receive signal paths may be done solely in the RF circuitry 806, solely in the FEM 808, or in both the RF circuitry 806 and the FEM 808.

In some embodiments, the FEM circuitry 808 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 806). The transmit signal path of the FEM circuitry 808 may include a power amplifier (PA) to amplify input RF signals (e.g., provided by RF circuitry 806), and one or more filters to generate RF signals for subsequent transmission (e.g., by one or more of the one or more antennas 810).

In some embodiments, the PMC 812 may manage power provided to the baseband circuitry 804. In particular, the PMC 812 may control power-source selection, voltage scaling, battery charging, or DC-to-DC conversion. The PMC 812 may often be included when the device 800 is capable of being powered by a battery, for example, when the device is included in a UE. The PMC 812 may increase the power conversion efficiency while providing desirable implementation size and heat dissipation characteristics.

While FIG. 8 shows the PMC 812 coupled only with the baseband circuitry 804, in other embodiments the PMC 812 may be additionally or alternatively coupled with, and perform similar power management operations for, other components such as, but not limited to, application circuitry 802, RF circuitry 806, or FEM 808.

In some embodiments, the PMC 812 may control, or otherwise be part of, various power saving mechanisms of the device 800. For example, if the device 800 is in an RRC_Connected state, where it is still connected to the RAN node as it expects to receive traffic shortly, then it may enter a state known as Discontinuous Reception Mode (DRX) after a period of inactivity. During this state, the device 800 may power down for brief intervals of time and thus save power.

If there is no data traffic activity for an extended period of time, then the device 800 may transition off to an RRC_Idle state, where it disconnects from the network and does not perform operations such as channel quality feedback, handover, etc. The device 800 goes into a very low power state and it performs paging where again it periodically wakes up to listen to the network and then powers down again. The device 800 may not receive data in this state, in order to receive data, it will transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 802 and processors of the baseband circuitry 804 may be used to execute elements of one or more instances of a protocol stack. For example, processors of the baseband circuitry 804, alone or in combination, may be used execute Layer 3, Layer 2, or Layer 1 functionality, while processors of the application circuitry 804 may utilize data (e.g., packet data) received from these layers and further execute Layer 4 functionality (e.g., transmission communication protocol (TCP) and user datagram protocol (UDP) layers). As referred to herein, Layer 3 (L3) may comprise a radio resource control (RRC) layer, described in further detail below. As referred to herein, Layer 2 (L2) may comprise a medium access control (MAC) layer, a radio link control (RLC) layer, and a packet data convergence protocol (PDCP) layer, described in further detail below. As referred to herein, Layer 1 (L1) may comprise a physical (PHY) layer of a UE/RAN node, described in further detail below.

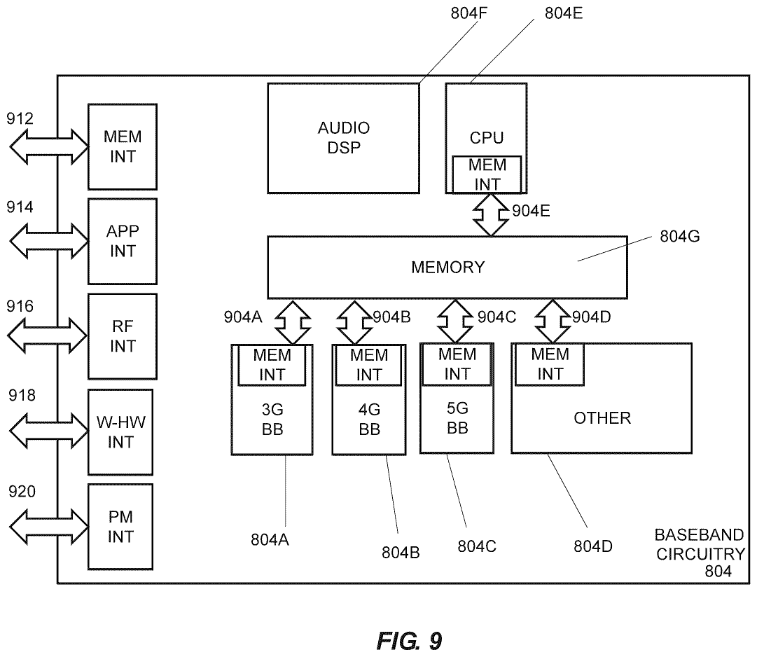

### FIG. 9: Block Diagram of an Interface of Baseband Circuitry

FIG. 9 illustrates example interfaces of baseband circuitry in accordance with some embodiments. It is noted that the baseband circuitry of FIG. 9 is merely one example of a possible circuitry, and that features of this disclosure may be implemented in any of various systems, as desired.

As discussed above, the baseband circuitry 804 of FIG. 8 may comprise processors 804A-804E and a memory 804G utilized by said processors. Each of the processors 804A-804E may include a memory interface, 904A-904E, respectively, to send/receive data to/from the memory 804G.

The baseband circuitry 804 may further include one or more interfaces to communicatively couple to other circuitries/devices, such as a memory interface 912 (e.g., an interface to send/receive data to/from memory external to the baseband circuitry 804), an application circuitry interface 914 (e.g., an interface to send/receive data to/from the application circuitry 802 of FIG. 8), an RF circuitry interface 916 (e.g., an interface to send/receive data to/from RF circuitry 806 of FIG. 8), a wireless hardware connectivity interface 918 (e.g., an interface to send/receive data to/from Near Field Communication (NFC) components, Bluetooth® components (e.g., Bluetooth® Low Energy), Wi-Fi® components, and other communication components), and a power management interface 920 (e.g., an interface to send/receive power or control signals to/from the PMC 812.

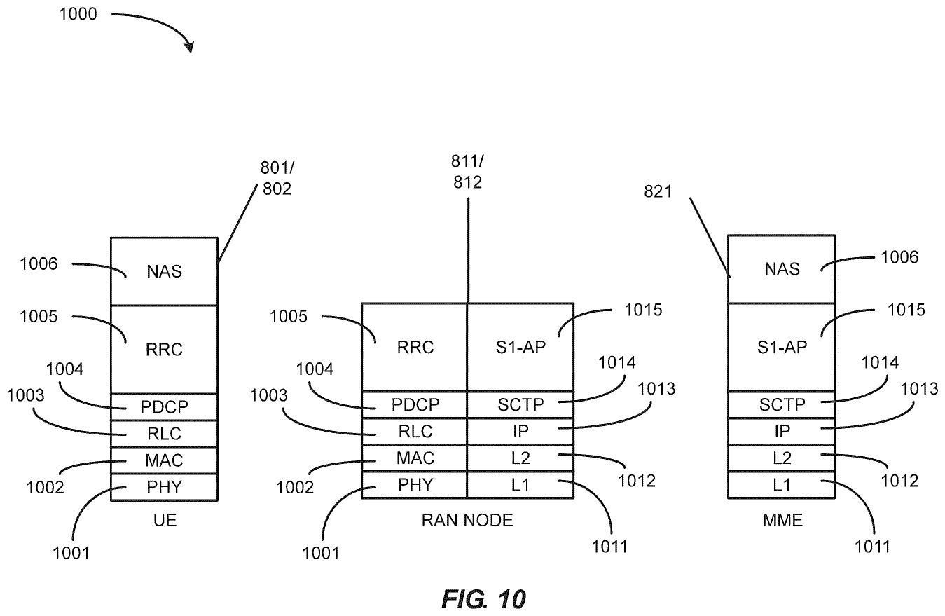

### FIG. 10: Block Diagram of a Control Plane Protocol Stack

FIG. 10 is an illustration of a control plane protocol stack in accordance with some embodiments. It is noted that the stack of FIG. 10 is merely one example of a possible stack, and that features of this disclosure may be implemented in any of various systems, as desired.

In this embodiment, a control plane 1000 is shown as a communications protocol stack between the UE 106, a RAN node, and a MME.

The PHY layer 1001 may transmit or receive information used by the MAC layer 1002 over one or more air interfaces. The PHY layer 1001 may further perform link adaptation or adaptive modulation and coding (AMC), power control, cell search (e.g., for initial synchronization and handover purposes), and other measurements used by higher layers, such as the RRC layer 1005. The PHY layer 1001 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer 1002 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

The RLC layer 1003 may operate in a plurality of modes of operation, including: Transparent Mode (TM), Unacknowledged Mode (UM), and Acknowledged Mode (AM). The RLC layer 1003 may execute transfer of upper layer protocol data units (PDUs), error correction through automatic repeat request (ARQ) for AM data transfers, and concatenation, segmentation, and reassembly of RLC SDUs for UM and AM data transfers. The RLC layer 1003 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer 1004 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer 1005 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection between the UE and E-UTRAN (e.g., RRC connection paging, RRC connection establishment, RRC connection modification, and RRC connection release), establishment, configuration, maintenance and release of point to point Radio Bearers, security functions including key management, inter radio access technology (RAT) mobility, and measurement configuration for UE measurement reporting. Said MIBs and SIBs may comprise one or more information elements (IEs), which may each comprise individual data fields or data structures.

The UE 106 and the RAN node may utilize a Uu interface (e.g., an LTE-Uu interface) to exchange control plane data via a protocol stack comprising the PHY layer 1001, the MAC layer 1002, the RLC layer 1003, the PDCP layer 1004, and the RRC layer 1005.

The non-access stratum (NAS) protocols 1006 form the highest stratum of the control plane between the UE 106 and the MME. The NAS protocols 1006 support the mobility of the UE 106 and the session management procedures to establish and maintain IP connectivity between the UE 106 and the P-GW.

The S1 Application Protocol (S1-AP) layer 1015 may support the functions of the S1 interface and comprise Elementary Procedures (EPS). An EP is a unit of interaction between the RAN node and the CN. The S1-AP layer services may comprise two groups: UE-associated services and non UE-associated services. These services perform functions including, but not limited to: E-UTRAN Radio Access Bearer (E-RAB) management, UE capability indication, mobility, NAS signaling transport, RAN Information Management (RIM), and configuration transfer.

The Stream Control Transmission Protocol (SCTP) layer (alternatively referred to as the SCTP/IP layer) 1014 may ensure reliable delivery of signaling messages between the RAN node and the MME based, in part, on the IP protocol, supported by the IP layer 1013. The L2 layer 1012 and the L1 layer 1011 may refer to communication links (e.g., wired or wireless) used by the RAN node and the MME to exchange information.

The RAN node and the MME may utilize an S1-MME interface to exchange control plane data via a protocol stack comprising the L1 layer 1011, the L2 layer 1012, the IP layer 1013, the SCTP layer 1014, and the S1-AP layer 1015.

The various layers illustrated in the example of FIG. 10 can be used to provide signaling between a UE and one or more nodes. One area in which signaling is used is to establish the use of carrier aggregation (CA) for communication between a UE and multiple nodes. Carrier Aggregation can enable higher data rates between for a UE. Higher data rates are one of the key promises in the implementation of the fifth generation (5G) of the 3GPP standard.

However, as 5G is becoming pervasive across industries and geographical areas, handling more advanced services and applications using high data rates, networks are being denser, use more antennas, with larger bandwidths and more frequency bands. This results in greater amounts of energy used at the UE, thereby reducing battery life at the UE. As previously discussed, one means for reducing power consumption is through the use of groups of cells used in carrier aggregation to include a secondary cell (SCell) that does not include an SSB. In addition, the SSB-less SCell may be designated for only UL communication. The inclusion of an SSB-less SCell in CA can reduce the amount of power consumed by the UE communicating with each SSB. But it also necessitates specific signaling to enable the UE to communicate with the SSB-less SCell, possibly only using UL signals.

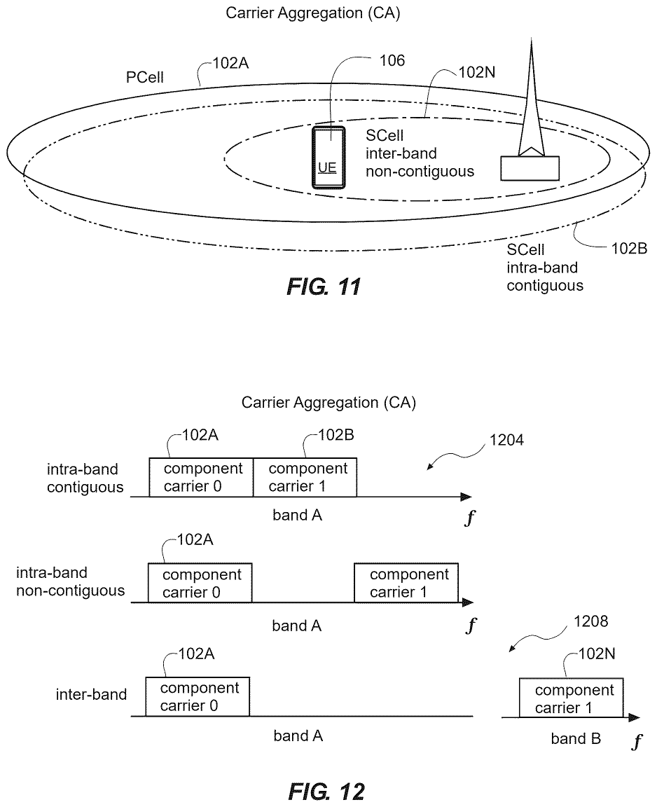

### FIGS. 11 and 12: Schematic Diagrams of a Carrier Aggregation System

FIGS. 11 and 12 illustrate a simplified example carrier aggregation system, according to some embodiments. It is noted that the system of FIGS. 11 and 12 is merely one example of a possible system, and that features of this disclosure may be implemented in any of various systems, as desired.

As described herein, one or more embodiments present signaling of inter-band carrier aggregation (CA) without a synchronization signal block (SSB-less), or SSB-less CA. One embodiment provides SSB-less secondary cell (SCell) operation for inter-band CA with co-located cells, where a user equipment (UE) 106 can measure timing and layer 3 (L3) measurements from an SSB associated with a primary cell (PCell) 102A, or another SCell, to use for the SSB-less SCell in a group of cells 102B . . . 102N used for CA. The technology disclosed in the embodiments can apply to frequency range 1 (FR1), or the sub-6 GHz frequency bands allocated to 5G or new radio (NR).

The following scenarios are considered for inter-band SSB-less SCell communication. In one scenario (Scenario 1), an SCell, in a group of cells used for CA, can be without SSB transmission but with a tracking reference signal (TRS) transmission configured on the SSB-less SCell during and/or after activation of the SCell. In another scenario (Scenario 2), an SCell, in a group of cells used for CA, is without SSB and without TRS transmission configured on the SSB-less SCell. In a similar scenario (Scenario 3), an SCell, in a group of cells used for CA, can be without an SSB and without any other downlink (DL) transmission, but with uplink (UL) reception at the network (NW) side on the SSB-less SCell.

FIG. 11 illustrates multiple different CA possibilities. In one example, the UE 106 can be in communication with a Pcell 102A. The PCell 102A can be designated as the active serving cell for the UE 106. The UE 106 can also be in communication, using CA, with a secondary cell 102B that can be co-located with the Pcell 102A. The component carriers (CC) for the SCell can be intra-band contiguous with the component carriers of the PCell, as shown in 1204 of FIG. 12. FIG. 12 shows the component carriers associated with the SCells of FIG. 11. In this case, the SCell can be an intra-band SSB-less SCell. The UE 106 can obtain timing information and L3 measurements from the serving cell, such as the PCell 102A in this example, which can be used by the UE 106 to communicate with the SSB-less SCell 102B.

When communicating using an intra-band SSB-less Scell the active serving cell can be used to acquire timing to communicate with the SSB-less Scell. With intra-band, the active serving cell has intra-band contiguous component carrier (CC) relative to the target SSB-less secondary component carriers (SCC). The serving cell can be a primary cell (PCell), a primary cell in a secondary cell group (PSCell), or an SCell that is in the same band as the target SCC, with CC that are contiguous to the target SCC.

In another embodiment, the cells 102 in FIG. 11 can be configured for CA communication with the UE 106 using inter-band SSB-less communication with an SCell. In this example, the UE 106 can be configured for CA to communicate with the PCell 102A and an SCell 102N. The component carriers assigned for the UE to communicate with the SCell 102N can be in a different band (i.e. band B) than the band of the component carriers assigned for the UE to communicate with the PCell 102A (i.e. band A). Since the component carriers of the PCell 102A and the SCell 102N are in different bands, they are, by definition, not contiguous, as shown in 1208 of FIG. 12. If the SCell 102N in this example does not include an SSB, then inter-band SSB-less communication may use different signaling than is used with intra-band SSB-less communication to enable the UE 106 to obtain the timing and L3 measurements to communicate with the SSB-less SCell 102N.

In accordance with one embodiment, as illustrated in the example of FIGS. 11 and 12, signaling and capability design is provided to address differences between intra-band SSB-less CA 1204 and inter-band SSB-less CA 1208. Multiple different embodiments are disclosed to address how the UE 106 can identify the cell, in the group of cells used for CA, that is used to acquire timing and L3 measurements to communicate with the SSB-less SCell in inter-band SSB-less CA.

In the intra-band case 1204, the UE 106 can assume that all of the cells in the group of cells are in a co-located deployment. For example, FIG. 11 shows a Pcell 102A that is co-located with the SCell 102b. In the inter-band case 1208, the UE can be assigned multiple inter-band CCs in a group of cells used for CA that includes an SSB-less SCell. In this case, a new indication of the cell used by the UE to obtain timing and L3 measurements may be used. The Per-FeatureSet capability of intra-band CA may not be sufficient for inter-band SSB-less CA.

In the inter-band SSB-less CA case, illustrated in the example of 1208 in FIG. 12, the UE may support inter-band SSB-less SCell communication only in a certain band combination of a PCell and a certain SCell. Without the use of additional signaling, the UE may not sufficiently support existing fallback band combinations because the fallback communication that has been used is assuming that a downlink (DL) CC is available. In certain embodiments, such as scenario 3, the SSB-less SCell may only support UL communication.

In one aspect, the UE can identify a cell to acquire timing without any new radio resource control (RRC) signaling. The UE can use one active serving cell which is configured to have intra-band contiguous CC to the SCC of the target SSB-less SCell, such as the embodiment illustrated as 1204 in FIG. 12. The active serving cell can be a PCell, a PSCell, or an SCell with CC in the same band as the SCC of the target SSB-less SCell and contiguous to the SCC of the target SSB-less SCell. If more than one cell is available, a UE implementation can be used to select which cell to use to obtain timing for the SSB-less SCell. A separate, per-featureSet signaling for inter-band SSB-less CC can be introduced similar to existing intra-band SSB-less capability scellWithSSB. This solution (Solution 1) can be applicable for Scenarios 1 and 3, as described herein, when intra-band contiguous CC with SSB is also configured.

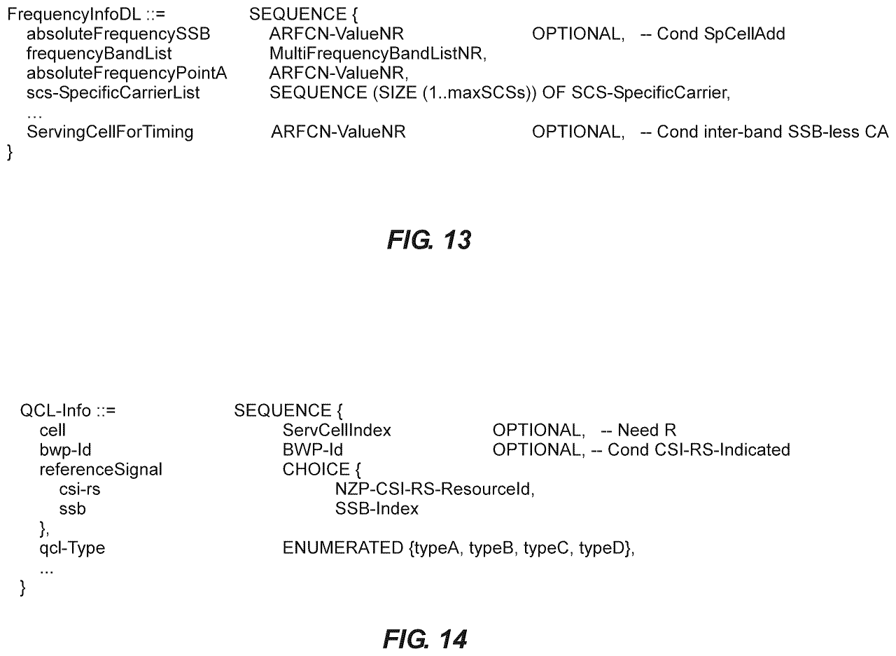

In another aspect, the UE can identify a cell to acquire timing with a new RRC signaling. A new RRC information element (IE) can be introduced to explicitly indicate which serving cell will be used by the UE to acquire timing and L3 measurement to configure the UE to communicate with the SSB-less Scell. An example of the new RRC IE signaling is provided in FIG. 13. For example, the RRC IE can be a Serving Cell For Timing (ServingCellForTiming) IE, or another desired identifier for the IE. The ServingCellForTiming IE can be a subset of a CellGroupConfig→SCellConfig→SCellConfigCommon→downlinkConfigCommon→frequencyInfoDL IE.

In one example, the data type of the new ServingCellForTiming IE can be frequency, with a New Radio Absolute Radio-Frequency Channel Number value for new radio (ARFCN-ValueNR) to receive information from an SSB from the serving cell indicated by the ARFCN-ValueNR. Alternatively, the new ServingCellForTiming IE can provide a serving cell index (SCellIndex) to identify the serving cell to use to receive one or more of a timing or L3 measurements from the serving cell indicated by the SCellIndex.

Either inter-band CC or intra-band CC can be indicated by the new IE. The presence condition of this IE (i.e. inter-band SSB-less CA) can be: this IE is mandatorily present when absoluteFrequencyPointA is absent and inter-band CA is configured. This solution (Solution 2-1) can be used for scenarios 1, 2, and 3, described herein.

In one embodiment, a per band combination (per-BC) signaling and bands of inter-band SSB-less CC can be explicitly specified in a list that can be included as part of a specification, such as the 3GPP specification. For example, in Table 5.2-1 of Section 5.2 of the 3GPP Technical Specification (TS) 38.101-1 (Release 18.2.0 June 2023), the NR operating bands for FR1 are listed. One column is a “duplex mode” that includes whether each band is designed for frequency division duplex (FDD) or time division duplex (TDD) communication. In addition, certain bands are designated to be used as a supplementary uplink (SUL). In a similar manner, certain of the NR bands included in Table 5.2-1 can be designated for use with component carriers used in inter-band SSB-less CA. The network can then derive a correct fallback band combination based on the list.

In one embodiment, the signaling can support an SCell without SSB transmission and without any other downlink (DL) transmission, but with uplink (UL) reception at the network (NW) side on the SSB-less SCell (Scenario 3). A current RRC IE field “pathlossReferenceLinking” is used to indicate how a UE can calculate UL transmission power based on the downlink pathloss Reference. This field can be insufficient when an inter-band CC with an SSB is used for timing and L3 measurement for the SSB-less SCell.

In one embodiment, when an RRC field (i.e. the new IE ServingCellForTiming is included within the existing IE frequencyInfoDL) to indicate the cell (i.e. in option 2 or 3) is present, the UE can use the indicated serving cell to calculate UL transmission power, and ignore the field pathlossReferenceLinking. Otherwise, when the RRC field is absent, the UE can apply the field pathlossReferenceLinking. When respect to UL transmission/retransmission, the downlink control information (DCI) may not send due to a lack of DL transmission when the SSB-less SCell is configured only for UL transmission from the UE. In one embodiment, the UE supporting UL only inter-band SSB-less CA can also support cross-carrier scheduling. The UE can rely on cross-carrier scheduling for the initial UL transmission and retransmission. The UE can perform configured-grant (CG), scheduling request (SR), and/or sounding reference signal (SRS) transmission as legacy except that the UE can rely on cross-carrier scheduling on CG retransmission.

A random access channel (RACH) may not be performed in inter-band SSB-less UL CC because there is no SSB in the same carrier to find a RACH occasion (RO). In one embodiment, the UE can be configured to not perform RACH in inter-band SSB-less UL CCs. In addition, the NW may not configure RACH related configuration (e.g. RO and transmit power setting) in inter-band SSB-less UL CC.

The UE may perform radio link monitoring (RLM) only in a PCell or a PSCell as legacy. In one embodiment, the UE may not perform SCell beam failure recovery (BFR) in inter-band SSB-less UL CC because there is no DL reference signals (RS) in the CC to perform beam failure detection (BFD). In in inter-band SSB-less CA, if the NW releases the serving cell for timing and L3 measurement, the NW can also release the inter-band SSB-less UL CC.

For inter-band SSB-less UL CC, the NW can configure a physical uplink shared channel (PUSCH), a physical uplink control channel (PUCCH), a scheduling request (SR), a configured-grant (CG), and a sounding reference signal (SRS). In addition, the NW may not configure any DL related configuration, such as a physical downlink shared channel (PDSCH), a physical downlink control channel (PDCCH), a signaling protocols and switching (SPS), and a random access channel (RACH) configuration.

In another aspect, the UE can find a cell to acquire timing by re-using the RRC IE quasi co location (QCL) indication of TRS of an SSB-less carrier. An example of the new RRC IE signaling is provided in FIG. 14. The RRC IE can be a non-zero-power channel-state-information reference signal resource set (NZP-CSI-RS-ResourceSet) IE that includes a QCL information field with a serving cell index (ServCellIndex) for the UE to use to acquire a timing and layer 3 (L3) measurements for the SSB-less SCell. The QCLed SSB index can also be acquired via the field of referenceSignal in QCL-Info. This solution (Solution 2-2) can be used with Scenario 1, as described herein, when TRS is configured.

In another aspect, the UE can identify a cell to acquire timing with Solutions 2 and 1, as described herein. When the RRC IE is present (i.e. the new IE ServingCellForTiming is included within the existing IE frequencyInfoDL), the UE can use the indicated serving cell for timing acquisition. When the RRC IE is absent, the UE can use at least one active serving cell which is an intra-band contiguous CC to the target SSB-less SCC.

A new RRC IE can be introduced to explicitly indicate which serving cell to acquire timing and L3 measurement. This solution (Solution 2-1) can be applicable to: scenario 1 (no SSB but TRS transmission configured on SSB-less SCell); 2 (no SSB and no TRS transmission configured on SSB-less SCell); and 3 (no DL transmission but UL reception at NW side on SSB-less SCell).

The user equipment (UE) 106 can have one or more processors 204 or 804 configured to decode, at the UE 106, a radio resource control (RRC) information element (IE), for a cell group configuration of a group of cells including a secondary cell (SCell) 102N without a synchronization signal block (SSB-less) that are used for inter-band carrier aggregation (CA). In one aspect, the UE 106 can have an antenna 435 or 810 coupled to the one or more processors 204 or 804 configured to receive the RRC IE and send the RRC IE to the baseband circuitry 804 for decoding. The RRC IE can indicate a serving cell in the group of cells for the UE to use to acquire a timing and layer 3 (L3) measurements to use for the SSB-less SCell 102N. The one or more processors 204 or 804 can be configured to decode, at the UE 106, the timing and L3 measurements from the serving cell indicated by the RRC IE to enable the one or more processors 204 or 804 to encode data for transmission from the UE 106 to the SSB-less SCell 102N based on one or more of the timing or L3 measurements from the serving cell. In one aspect, the UE 106 can have the antenna 435 or 810 coupled to the one or more processors 204 or 804 configured to receive the timing and L3 measurements and send the timing and L3 measurements to the baseband circuitry 804 for decoding. In another aspect, the baseband circuitry 804 can send the data to the antenna 435 or 810 for transmission. The UE can also have a memory 260 or 804G coupled to the one or more processors 204 or 804. In one aspect, the memory 260 or 804G can be configured to store the one or more of the timing or L3 measurement from the serving cell indicated by the RRC IE.

In one aspect, the RRC IE can comprise a New Radio Absolute Radio-Frequency Channel Number value (ARFCN-ValueNR) to receive an SSB from the serving cell indicated by the ARFCN-ValueNR. In another aspect, the RRC IE can comprise a serving cell index (SCellIndex) to identify the serving cell to use to receive the one or more of the timing or the L3 measurements from the serving cell indicated by the SCellIndex.

In one aspect, the serving cell indicated by the RRC IE can comprise inter-band component carriers (CC). In another aspect, the serving cell indicated by the RRC IE can comprise intra-band CC.

In one aspect, the RRC IE can be a Serving Cell For Timing (ServingCellForTiming) IE. The ServingCellForTiming IE can be a subset of a CellGroupConfig→SCellConfig→SCellConfigCommon→downlinkConfigCommon→frequencyInfoDL IE.

In one aspect, the RRC IE can be a non-zero-power channel-state-information reference signal resource set (NZP-CSI-RS-ResourceSet) IE that includes a quasi co location (QCL) information field with a serving cell index (ServCellIndex) for the UE to use to acquire a timing and layer 3 (L3) measurements for the SSB-less SCell. As described herein, this can be applicable to Scenario 1 (no SSB but TRS transmission configured on SSB-less SCell).

In another aspect, inter-band component carriers (CC) in the SSB-less SCell can be within a predetermined band that is selected to be an inter-band SSB-less band to enable per-band combination signaling.

In another aspect, the one or more processors can be further configured to calculate, at the UE, uplink (UL) transmission power to the SSB-less SCell based on downlink (DL) power measurements from the indicated serving cell in the RRC IE. The one or more processors can be further configured to calculate the UL transmission power to the SSB-less SCell based on the DL power measurements from the serving cell in the RRC IE when the RRC IE is present. The one or more processors can further calculate the UL transmission power to the SSB-less SCell based on a pathloss reference linking (PathlossReferenceLinking) field decoded at the UE when the RRC IE is absent.

In another aspect, the one or more processors can be further configured to encode, at the UE, data for retransmission using cross-carrier scheduling for configured-grant (CG) retransmission.

In another aspect, the one or more processors can be further configured to perform one or more of, at the UE: radio link monitoring (RLM) only in cells in the group of cells consisting of a primary cell (Pcell) or a Primary secondary cell group (SCG) Cell (PSCell); or a random access channel (RACH) procedure only in cells in the group of cells that include an SSB; or beam failure recovery (BFR) only in cells in the group of cells that include an SSB.

In another aspect, the one or more processors can be further configured to decode, at the UE, configuration information for the SSB-less SCell one or more of a physical uplink channel (PUSCH), a physical uplink control channel (PUCCH), a scheduling request (SR), a configured-grant (CG), and a sounding reference signal (SRS).

In another aspect, the one or more processors can be further configured to decode, at the UE, configuration information for cells in the group of cells that include the SSB, one or more of a physical downlink channel (PDSCH), a physical downlink control channel (PDCCH), and a signaling protocols and switching (SPS).

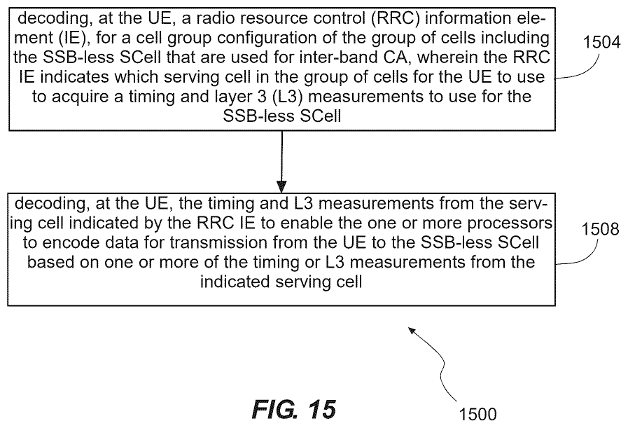

### FIG. 15: Flow Chart of a Carrier Aggregation Method

FIG. 15 illustrates a carrier aggregation method, according to some embodiments. It is noted that the method of FIG. 15 is merely one example of a possible method, and that features of this disclosure may be implemented in any of various methods or system, as desired.

A method 1500 for inter-band carrier aggregation (CA) in a group of cells including a secondary cell (SCell) 102N without a synchronization signal block (SSB-less) is shown. The method can comprise decoding 1504, at the UE 106, a radio resource control (RRC) information element (IE), for a cell group configuration of the group of cells including the SSB-less SCell 102N that are used for inter-band CA. In one aspect, the method can further comprise receiving the RRC IE from the gNB 102 and sending the RRC IE to the baseband circuitry 804 for decoding. The RRC IE can indicate which serving cell in the group of cells for the UE 106 to use to acquire a timing and layer 3 (L3) measurements to use for the SSB-less SCell 102N. The method can also comprise decoding 1508, at the UE 106, the timing and layer 3 measurements from the serving cell indicated by the RRC IE to enable the one or more processors to encode data for transmission from the UE 106 to the SSB-less SCell 102N based on one or more of the timing or L3 measurements from the indicated serving cell.

In one aspect, the method can comprise calculating, at the UE, uplink (UL) transmission power based on downlink (DL) power measurements from the indicated serving cell in the RRC IE. The method can comprise calculating, at the UE, the UL transmission power based on the DL power measurements from the serving cell in the RRC IE when the RRC IE is present. In addition, the method can comprise identifying, at the UE, the UL transmission power based on a pathloss reference linking (PathlossReferenceLinking) field decoded at the UE to determine the UL transmission power to the SSB-less SCell when the RRC IE is absent.

In another aspect, the method can comprise encoding, at the UE, data for retransmission using cross-carrier scheduling for configured-grant (CG) retransmission.

In another aspect, the method can comprise performing one or more of, at the UE: radio link monitoring (RLM) only in cells in the group of cells consisting of a primary cell (Pcell) or a Primary cell in a secondary cell group (SCG) Cell (PSCell); or a random access channel (RACH) procedure only in cells in the group of cells that include an SSB; or beam failure recovery only in cells in the group of cells that include an SSB.

In another aspect, the method can comprise decoding, at the UE, configuration information for the SSB-less SCell, received via one or more of a physical uplink channel (PUSCH), a physical uplink control channel (PUCCH), a scheduling request (SR), a configured-grant (CG), and a sounding reference signal (SRS).

In another aspect, the method can comprise decoding, at the UE, configuration information for cells in the group of cells that include the SSB, received via one or more of a physical downlink channel (PDSCH), a physical downlink control channel (PDCCH), and a signaling protocols and switching (SPS).

Aspects of the RRC IE, the serving cell, and the inter-band CC are described herein.

Referring again to FIGS. 11 and 12, a QCL indication of TRS of SSB-less carrier can be reused. This solution, Solution 2-2, can be applicable to Scenario 1 (no SSB but TRS transmission configured on SSB-less SCell).

A user equipment (UE) 106 can have one or more processors 204 or 804 configured to decode, at the UE 106, a radio resource control (RRC) information element (IE), for a group of cells including a secondary cell (SCell) 102N without a synchronization signal block (SSB-less) that are used for inter-band carrier aggregation (CA). In one aspect, the UE 106 can have an antenna 435 or 810 coupled to the one or more processors 204 or 804 configured to receive the RRC IE and send the RRC IE to the baseband circuitry 804 for decoding. The RRC IE can be a non-zero-power channel-state-information reference signal resource set (NZP-CSI-RS-ResourceSet) IE that includes a quasi co location (QCL) information field with a serving cell index (ServCellIndex) for the UE to use to acquire a timing and layer 3 (L3) measurements for the SSB-less SCell 102N. In addition, the one or more processors can decode, at the UE 106, the timing and L3 measurements from the ServCellIndex indicated by the QCL information field of the NZP-CSI-RS-ResourceSet IE to enable the one or more processors to encode data for transmission from the UE 106 to the SSB-less SCell 102N based on one or more of the timing or L3 measurements. In one aspect, the UE 106 can have the antenna 435 or 810 coupled to the one or more processors 204 or 804 configured to receive the timing and L3 measurements and send the timing and L3 measurements to the baseband circuitry 804 for decoding. In another aspect, the baseband circuitry 804 can send the data to the antenna 435 or 810 for transmission. The UE 106 can also have a memory 260 and 804G coupled to the one or more processors 204 or 804. In one aspect, the memory 260 and 804G can be configured to store the one or more of the timing or L3 measurements.

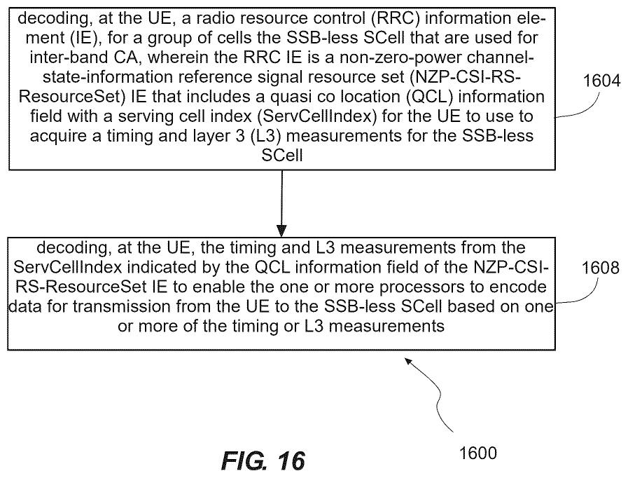

### FIG. 16: Flow Chart of a Carrier Aggregation Method

FIG. 16 illustrates a carrier aggregation method, according to some embodiments. It is noted that the method of FIG. 16 is merely one example of a possible method, and that features of this disclosure may be implemented in any of various methods or system, as desired.

A method 1600 for inter-band carrier aggregation (CA) in a group of cells including a secondary cell (SCell) 102N without a synchronization signal block (SSB-less) can comprise decoding 1604, at the UE 106, a radio resource control (RRC) information element (IE), for a group of cells including the SSB-less SCell 102N that are used for inter-band CA. In one aspect, the method can further comprise receiving the RRC IE from the gNB 102 and sending the RRC IE to the baseband circuitry 804 for decoding. The RRC IE can be a non-zero-power channel-state-information reference signal resource set (NZP-CSI-RS-ResourceSet) IE that includes a quasi co location (QCL) information field with a serving cell index (ServCellIndex) for the UE 106 to use to acquire a timing and layer 3 (L3) measurements for the SSB-less SCell 102N. In addition, the method 1600 can comprise decoding 1608, at the UE, the timing and L3 measurements from the ServCellIndex indicated by the QCL information field of the NZP-CSI-RS-ResourceSet IE to encode data for transmission from the UE 106 to the SSB-less SCell 102N based on one or more of the timing or L3 measurements.

Referring again to FIGS. 11 and 12, no new RRC signaling may be provided in one aspect. The UE 106 can use an active serving cell with an intra-band contiguous CC 120B to the target SSB-less SSC with an SSB configured. This solution (Solution 1) can be applicable for scenarios 1 (no SSB but TRS transmission configured on SSB-less SCell) and 2a (no DL transmission but UL reception at NW side on SSB-less SCell).

A user equipment (UE) 106 can be operable for inter-band carrier aggregation (CA) for a group of co-located cells including a secondary cell (SCell) 102N without a synchronization signal block (SSB-less). The UE 16 can have one or more processors 204 or 804 configured to identify, at the UE 106, an active serving cell in a group of cells including a secondary cell (SCell) 102N without a synchronization signal block (SSB-less) that are used for inter-band carrier aggregation (CA). The active serving cell is intra-band contiguous with component carriers (CC) in the SSB-less SCell 102N. In addition, the one or more processors 204 or 804 can be configured to decode, at the UE 106, timing and layer 3 (L3) measurements from the active serving cell information element (IE) to enable the one or more processors 204 or 804 to encode data for transmission from the UE 106 to the SSB-less SCell 102N based on one or more of the timing or L3 measurements from the active serving cell. In one aspect, the UE 106 can have the antenna 435 or 810 coupled to the one or more processors 204 or 804 configured to receive the timing and L3 measurements and send the timing and L3 measurements to the baseband circuitry 804 for decoding. In another aspect, the baseband circuitry 804 can send the data to the antenna 435 or 810 for transmission. The UE 106 can also have a memory 260 or 804G coupled to the one or more processors 204 or 804. In one aspect, the memory 260 or 804G can be configured to store the timing from the active serving cell.

Various aspects described herein can also be combined. For example, the Solutions 1 and 2 can be combined. A user equipment (UE) 106 can have one or more processors 204 or 804 configured to identify, at the UE 106, a radio resource control (RRC) information element (IE) when the RRC IE is present (Solution 2), for a cell group configuration of a group of cells including a secondary cell (SCell) 102N without a synchronization signal block (SSB-less) that are used for inter-band carrier aggregation (CA). In one aspect, the UE 106 can have an antenna 435 or 810 coupled to the one or more processors 204 or 804 configured to receive the RRC IE and identify the active serving cell in the RRC IE. The RRC IE can indicate a serving cell in the group of cells for the UE 106 to use to acquire a timing and layer 3 (L3) measurements to use for the SSB-less Scell 102N. In addition, the one or more processors 204 or 804 can be configured to decode, at the UE 106, when the RRC IE is present (Solution 2), the timing and L3 measurements from the serving cell indicated by the RRC IE to enable the one or more processors 204 or 804 to encode data for transmission from the UE 106 to the SSB-less Scell 102N based on one or more of the timing or L3 measurements from the serving cell. In one aspect, the UE 106 can have an antenna 435 or 810 coupled to the one or more processors 204 or 804 configured to receive the RRC IE and send the RRC IE to the baseband circuitry 804 for decoding. Furthermore, the one or more processors 204 or 804 can be configured to identify, at the UE 106, when the RRC IE is absent (Solution 1), timing or L3 measurements from an intra-band serving cell in the group of cells that includes intra-band contiguous component carriers (CC) to the SSB-less Scell 102N to enable the one or more processors 204 or 804 to encode data for transmission from the UE 106 to the SSB-less SCell 102N based on one or more of the timing or L3 measurements from the serving cell. In one aspect, the UE 106 can have the antenna 435 or 810 coupled to the one or more processors 204 or 804 configured to receive the timing and L3 measurements and send the timing and L3 measurements to the baseband circuitry 804 for decoding. In another aspect, the baseband circuitry 804 can send the data to the antenna 435 or 810 for transmission. The UE 106 can have a memory 260 or 804G coupled to the one or more processors 204 or 804. In one aspect, the memory 260 or 804G can be configured to store the one or more of the timing or L3 measurements from the serving cell indicated by the RRC IE when the RRC IE is present (Solution 1), or the one or more of the timing or L3 measurements from the intra-band serving cell when the RRC IE is absent (Solution 2).

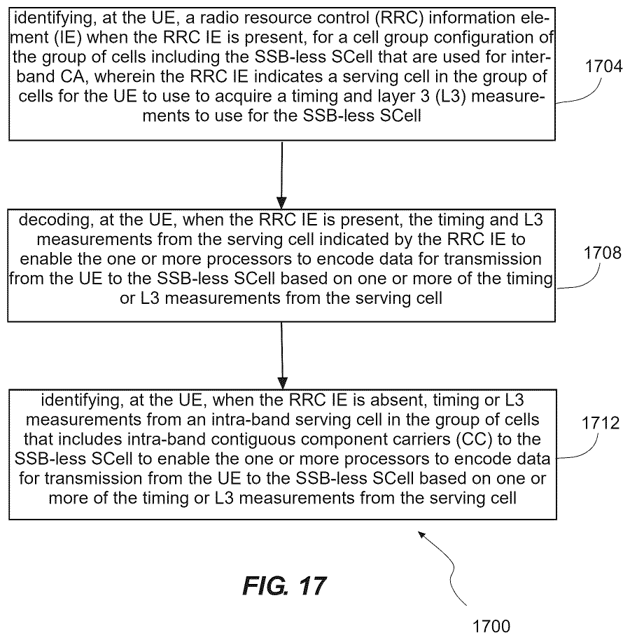

### FIG. 17: Flow Chart of a Carrier Aggregation Method

FIG. 17 illustrates a carrier aggregation method, according to some embodiments. It is noted that the method of FIG. 17 is merely one example of a possible method, and that features of this disclosure may be implemented in any of various methods or system, as desired.

A method 1700 for inter-band carrier aggregation (CA) in a group of cells including a secondary cell (SCell) 102N without a synchronization signal block (SSB-less) can comprise identifying 1704, at the UE 106, a radio resource control (RRC) information element (IE) when the RRC IE is present (Solution 2), for a cell group configuration of the group of cells including the SSB-less SCell 102N that are used for inter-band CA. In one aspect, the method can further comprise receiving the RRC IE from the gNB 102 and sending the RRC IE to the baseband circuitry 804 for identification. The RRC IE can indicate a serving cell in the group of cells for the UE 106 to use to acquire a timing and layer 3 (L3) measurements to use for the SSB-less SCell 102N. In addition, the method can comprise decoding 1708, at the UE 106, when the RRC IE is present (Solution 2), the timing and L3 measurements from the serving cell indicated by the RRC IE to enable the one or more processors to encode data for transmission from the UE 106 to the SSB-less SCell 102N based on one or more of the timing or L3 measurements from the serving cell. Furthermore, the method can comprise identifying 1712, at the UE 106, when the RRC IE is absent (Solution 1), timing or L3 measurements from an intra-band serving cell in the group of cells that includes intra-band contiguous component carriers (CC) to the SSB-less SCell 102N to encode data for transmission from the UE 106 to the SSB-less SCell 102N based on one or more of the timing or L3 measurements from the serving cell.

In one aspect, the steps of the method can be performed by one or more processors. The method can include storing in a memory coupled to the one or more processors the one or more of the timing or L3 measurements from the serving cell indicated by the RRC IE when the RRC IE is present (Solution 2), or the one or more of the timing or L3 measurements from the intra-band serving cell when the RRC IE is absent (Solution 1).

In one aspect, the intra-band serving cell can be a primary cell (PCell) that is intra-band and contiguous with component carriers in the SSB-less SCell.

In another aspect, the intra-band serving cell can be a primary secondary cell (PSCell) that is intra-band and contiguous with component carriers in the SSB-less SCell.

In another aspect, the intra-band serving cell can be a secondary cell (SCell) that is intra-band and contiguous with component carriers in the SSB-less SCell.

In another aspect, the method can comprise calculating, at the UE, uplink (UL) transmission power to the SSB-less SCell based on downlink (DL) power measurements from the indicated serving cell in the RRC IE.

In another aspect, the method can comprise calculating, at the UE, the UL transmission power to the SSB-less SCell based on the DL power measurements from the serving cell in the RRC IE when the RRC IE is present. In addition, the method can comprise using a pathloss reference linking (PathlossReferenceLinking) field decoded at the UE to determine the UL transmission power to the SSB-less SCell when the RRC IE is absent.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

1. An apparatus of a user equipment (UE), the apparatus comprising:
one or more processors configured to:
decode, at the UE, a radio resource control (RRC) information element (IE), for a cell group configuration of a group of cells including a secondary cell (SCell) without a synchronization signal block (SSB-less) that are used for inter-band carrier aggregation (CA), wherein the RRC IE indicates a serving cell in the group of cells for the UE to use to acquire a timing and layer 3 (L3) measurements to use for the SSB-less SCell; and
decode, at the UE, the timing and L3 measurements from the serving cell indicated by the RRC IE to enable the one or more processors to encode data for transmission from the UE to the SSB-less SCell based on one or more of the timing or L3 measurements from the serving cell; and
a memory coupled to the one or more processors.

2. The apparatus of claim 1, wherein the RRC IE comprises:
a New Radio Absolute Radio-Frequency Channel Number value (ARFCN-ValueNR) to receive an SSB from the serving cell indicated by the ARFCN-ValueNR; or
a serving cell index (SCellIndex) to identify the serving cell to use to receive the one or more of the timing or the L3 measurements from the serving cell indicated by the SCellIndex.

3. The apparatus of claim 1, wherein the serving cell indicated by the RRC IE comprises inter-band component carriers (CC).

4. The apparatus of claim 1, wherein the serving cell indicated by the RRC IE comprises intra-band CC.

5. The apparatus of claim 1, wherein the RRC IE is a Serving Cell For Timing (ServingCellForTiming) IE.

6. The apparatus of claim 5, wherein the ServingCellForTiming IE is a subset of a CellGroupConfig→SCellConfig→SCellConfigCommon→downlinkConfigCommon→frequencyInfoDL IE.

7. (canceled)

8. The apparatus of claim 1, wherein inter-band component carriers (CC) in the SSB-less SCell are within a predetermined band that is selected to be an inter-band SSB-less band to enable per-band combination signaling.

9. The apparatus of claim 1, wherein the one or more processors are further configured to:
calculate, at the UE, uplink (UL) transmission power to the SSB-less SCell based on downlink (DL) power measurements from the indicated serving cell in the RRC IE.

10. The apparatus of claim 9, wherein the one or more processors are further configured to:
calculate the UL transmission power to the SSB-less SCell based on the DL power measurements from the serving cell in the RRC IE when the RRC IE is present; and
calculate the UL transmission power to the SSB-less SCell based on a pathloss reference linking (PathlossReferenceLinking) field decoded at the UE when the RRC IE is absent.

11. The apparatus of claim 1, wherein the one or more processors are further configured to:
encode, at the UE, data for retransmission using cross-carrier scheduling for configured-grant (CG) retransmission.

12. The apparatus of claim 1, wherein the one or more processors are further configured to perform one or more of, at the UE:
radio link monitoring (RLM) only in cells in the group of cells consisting of a primary cell (Pcell) or a Primary secondary cell group (SCG) Cell (PSCell); or
a random access channel (RACH) procedure only in cells in the group of cells that include an SSB; or
beam failure recovery only in cells in the group of cells that include an SSB.

13. The apparatus of claim 1, wherein the one or more processors are further configured to:
decode, at the UE, configuration information for the SSB-less SCell one or more of a physical uplink channel (PUSCH), a physical uplink control channel (PUCCH), a scheduling request (SR), a configured-grant (CG), and a sounding reference signal (SRS).

14. The apparatus of claim 1, wherein the one or more processors are further configured to:
decode, at the UE, configuration information for cells in the group of cells that include the SSB, one or more of a physical downlink channel (PDSCH), a physical downlink control channel (PDCCH), and a signaling protocols and switching (SPS).

15. A method for inter-band carrier aggregation (CA) in a group of cells including a secondary cell (SCell) without a synchronization signal block (SSB-less), the method comprising:
decoding, at the UE, a radio resource control (RRC) information element (IE), for a cell group configuration of the group of cells including the SSB-less SCell that are used for inter-band CA, wherein the RRC IE indicates which serving cell in the group of cells for the UE to use to acquire a timing and layer 3 (L3) measurements to use for the SSB-less SCell; and
decoding, at the UE, the timing and L3 measurements from the serving cell indicated by the RRC IE to encode data for transmission from the UE to the SSB-less SCell based on one or more of the timing or L3 measurements from the indicated serving cell.

16. The method of claim 15, wherein the RRC IE comprises:
a New Radio Absolute Radio-Frequency Channel Number value (ARFCN-ValueNR) to receive an SSB from the serving cell indicated by the ARFCN-ValueNR; or
a serving cell index (SCellIndex) to identify the serving cell to use to receive the one or more of the timing or the L3 measurements from the serving cell indicated by the SCellIndex.

17. The method of claim 15, wherein the serving cell indicated by the RRC IE comprises inter-band component carriers (CC) or intra-band CC.

18. (canceled)

19. The method of claim 15, wherein the RRC IE is a Serving Cell For Timing (ServingCellForTiming) IE.

20. The method of claim 19, wherein the ServingCellForTiming IE is a subset of a CellGroupConfig→SCellConfig→SCellConfigCommon→downlinkConfigCommon→frequencyInfoDL IE.

21. The method of claim 15, wherein the RRC IE is a non-zero-power channel-state-information reference signal resource set (NZP-CSI-RS-ResourceSet) IE that includes a quasi co location (QCL) information field with a serving cell index (ServCellIndex) for the UE to use to acquire a timing and layer 3 (L3) measurements for the SSB-less.

22-44. (canceled)

45. An apparatus of a user equipment (UE) operable for inter-band carrier aggregation (CA) for a group of co-located cells including a secondary cell (SCell) without a synchronization signal block (SSB-less), the apparatus comprising:
one or more processors configured to:
identify, at the UE, an active serving cell in a group of cells including a secondary cell (SCell) without a synchronization signal block (SSB-less) that are used for inter-band carrier aggregation (CA), wherein the active serving cell is intra-band contiguous with component carriers (CC) in the SSB-less SCell;
decode, at the UE, timing and layer 3 (L3) measurements from the active serving cell information element (IE) to enable the one or more processors to encode data for transmission from the UE to the SSB-less SCell based on one or more of the timing or L3 measurements from the active serving cell; and
a memory coupled to the one or more processors.
